(19) United States
(12) Patent Application Publication
(10) Pub. No.: US 2026/0151284 A1
(43) Pub. Date: Jun. 4, 2026

(54) SUPPORT SURFACE FOR A PATIENT SUPPORT APPARATUS AND METHOD FOR FORMING AN INFLATABLE BLADDER ASSEMBLY FOR A SUPPORT SURFACE

(71) Applicant: UMANO MEDICAL INC., L'Islet (CA)

(72) Inventors: Pascal POULIN, Levis (CA); Sylvain LACASSE, Quebec (CA)

(73) Assignee: UMANO MEDICAL INC., L'Islet (CA)

(21) Appl. No.: 19/394,983

(22) Filed: Nov. 20, 2025

Related U.S. Application Data
(60) Provisional application No. 63/726,378, filed on Nov. 29, 2024.

(51) Int. Cl. A61H 1/00; A61G 7/057; A61H 23/00; B29D 22/02; B29K 27/06; B29K 75/00

(52) U.S. Cl. CPC A61H 1/005; A61G 7/05776; A61H 23/006; B29D 22/023; A61H 2201/0103; A61H 2201/0146; A61H 2209/00; B29K 2027/06; B29K 2075/00

(57) ABSTRACT

A support surface for a patient support apparatus includes an inflatable bladder assembly including an inflatable bladder having a first layer defining a first aperture, a support located adjacent to the inflatable bladder, and having a second layer defining a second aperture axially aligned and overlapping with the first aperture. A first patch is connected to the first layer, extends across and covers the first aperture, and has an exterior face facing the support. A second patch is connected to the second layer, extends across and covers the second aperture, and has an exterior face facing the first inflatable bladder. The exterior face of the first patch is connected to the exterior face of the second patch at a patch connection, thereby connecting the inflatable bladder to the support. A method for forming an inflatable bladder assembly is also disclosed.

### CROSS-REFERENCE

The present application claims priority to U.S. Patent Application Ser. No. 63/726,378 titled “SUPPORT SURFACE FOR A PATIENT SUPPORT APPARATUS AND METHOD FOR FORMING AN INFLATABLE BLADDER ASSEMBLY FOR A SUPPORT SURFACE” filed Nov. 29, 2024, the entirety of which is incorporated herein by reference.

### TECHNICAL FIELD

The present technology relates to support surfaces for patient support apparatuses, such as hospital beds. More particularly, it concerns inflatable support surfaces.

### BACKGROUND

Respiratory therapy can be used for treating patients in intensive care units (ICU), particularly those with compromised lung function. Traditional methods of percussion and vibration therapy often require manual intervention, which can be inconsistent and labor-intensive.

There exist mattresses for hospital beds used in ICU that include percussion and vibration devices, being in the form of vibrating plates or inflatable/deflatable bladders, to perform at least some maneuvers of respiratory therapy. However, the effectiveness of such percussion and vibration devices can be mitigated by their location in the mattress, for instance when located between layers of foam forming the core of the mattress, and/or by their translation movements relative to the other components of the mattress, such movements occurring for instance when the patient moves on the mattress. In addition, the presence of such percussion and vibration devices may cause the appearance of undesirable imagery artifacts when an X-Ray imagery of the patient's torso is taken through at least a portion of the mattress including the percussion and vibration devices.

There is therefore a need for a support surface for a patient support apparatus that addresses at least in part some of these drawbacks.

### SUMMARY

It is an object of the present technology to ameliorate at least some of the inconveniences present in the prior art.

In accordance with one aspect, there is provided a support surface for a patient support apparatus including a core having an inflatable bladder assembly including an inflatable bladder including a first air impermeable flexible layer defining a first aperture, a support located adjacent to the inflatable bladder and including a second flexible layer different from the first layer, the second layer defining a second aperture axially aligned and overlapping with the first aperture, a first patch connected to the first layer, the first patch extending across and covering the first aperture, and having an exterior face facing the support, and a second patch connected to the second layer, the second patch extending across and covering the second aperture, and having an exterior face facing the inflatable bladder. The exterior face of the first patch is connected to the exterior face of the second patch at a patch connection and thereby connecting the inflatable bladder to the support.

In some embodiments, the first patch is connected to the second patch by radiofrequency welding the exterior face of the first patch to the exterior face of the second patch.

In some embodiments, the first patch has an interior face incompatible for radiofrequency welding with an interior face of the second patch.

In some embodiments, the first patch is made of a first patch material, the first layer is made of a first layer material, and the first patch material and the first layer material are identical.

In some embodiments, the second patch is made of a second patch material, the second layer is made of a second layer material, and the second patch material and the second layer material are identical.

In some embodiments, the exterior face of the first patch is connected to an interior face of the first layer facing opposite to the support.

In some embodiments, the exterior face of the second patch is connected to an interior face of the second layer facing opposite to the inflatable bladder.

In some embodiments, the support surface further includes a cover including a top cover and a base cover, the top cover and the base cover being connected to enclose the core, the top cover defining a top surface of the support surface, and, when in use, the inflatable bladder is located vertically between the top cover and the support.

In some embodiments, the support is an anchor strip.

In some embodiments, the inflatable bladder is part of a percussion and vibration bladder system of the support surface.

In some embodiments, the inflatable bladder is a first inflatable bladder, and the support is a second inflatable bladder having the second layer air impermeable.

In some embodiments, the patch connection is a first patch connection, the second layer further defines a third aperture, and the support surface further includes a third inflatable bladder located adjacent to the second inflatable bladder and offset of the first inflatable bladder, the third inflatable bladder including a third air impermeable flexible layer different from the second layer, the third layer defining a fourth aperture axially aligned and overlapping with the third aperture, a third patch connected to the second layer, the third patch extending across and covering the third aperture, and having an exterior face facing the third inflatable bladder, and a fourth patch connected to the third layer, the fourth patch extending across and covering the fourth aperture, and having an exterior face facing the second inflatable bladder, the exterior face of the third patch connected to the exterior face of the fourth patch at a second patch connection and thereby connecting the second inflatable bladder to the third inflatable bladder.

In accordance with another aspect, there is provided a method for forming an inflatable bladder assembly for an inflatable support surface for a patient support apparatus, including receiving a first air impermeable flexible blank defining a first aperture and a second blank defining a second aperture, connecting a first patch to the first blank so that the first patch extends across and covers the first aperture, connecting a second patch to the second blank so that the second patch extends across and covers the second aperture, locating the first blank adjacent to the second blank to axially align and overlap the first patch with the second patch, connecting an exterior face of the first patch to an exterior face of the second patch at a patch connection and thereby connecting the first blank to the second blank, folding the first blank to have corresponding edges superposed and engaged to one another, and coupling the corresponding edges of the first blank in an airtight manner to form an inflatable bladder.

In some embodiments, the connecting of the exterior face of the first patch to the exterior face of the second patch is made by radiofrequency welding.

In some embodiments, the connecting of the first patch includes connecting the exterior face of the first patch to an interior face of the first blank facing opposite to the second blank.

In some embodiments, the connecting of the second patch includes connecting the exterior face of the second patch to an interior face of the second blank facing opposite to the first blank.

In some embodiments, the second blank is an anchor strip.

In some embodiments, the second blank is an air impermeable flexible blank, and the method further comprises folding the second blank to have corresponding edges superposed and engaged to one another, and coupling the corresponding edges of the second blank in an airtight manner to form a second inflatable bladder.

In some embodiments, the method further includes, before the folding of the first blank, connecting a first bagport to the first blank.

In some embodiments, the method further includes, before the folding of the second blank, connecting a second bagport to the second blank.

In accordance with yet another aspect, there is provided a support surface for a patient support apparatus, including a core having an inflatable bladder assembly including a first inflatable bladder including a first air impermeable flexible layer defining a first aperture, a second inflatable bladder located adjacent to the first inflatable bladder and including a second air impermeable flexible layer different from the first layer, the second layer defining a second aperture axially aligned and overlapping with the first aperture, a first patch connected to the first layer, the first patch extending across and covering the first aperture, and having an exterior face facing the second inflatable bladder, and a second patch connected to the second layer, the second patch extending across and covering the second aperture, and having an exterior face facing the first inflatable bladder. The exterior face of the first patch is connected to the exterior face of the second patch at a patch connection thereby connecting the first inflatable bladder to the second inflatable bladder.

In accordance with yet another aspect, there is provided a method for forming an inflatable bladder assembly for an inflatable support surface for a patient support apparatus, including the steps of receiving a first air impermeable flexible blank defining a first aperture and a second air impermeable flexible blank defining a second aperture, connecting a first patch to the first blank so as to extend across and cover the first aperture, connecting a second patch to the second blank so as to extend across and cover the second aperture, locating the first blank adjacent to the second blank to axially align and overlap the first patch with the second patch;, connecting an exterior face of the first patch to an exterior face of the second patch at a patch connection and thereby connecting the first blank to the second blank, folding the first blank to have corresponding edges superposed and engaged to one another, coupling the corresponding edges of the first blank in an airtight manner to form a first inflatable bladder, folding the second blank to have corresponding edges superposed and engaged to one another, and coupling the corresponding edges of the second blank in an airtight manner to form a second inflatable bladder.

In accordance with yet another aspect, there is provided an inflatable bladder assembly for a support surface for a patient support apparatus, including a first inflatable bladder including a first air impermeable flexible layer defining a first aperture, a second inflatable bladder located adjacent to the first inflatable bladder and including a second air impermeable flexible layer different from the first layer, the second layer defining a second aperture axially aligned and overlapping with the first aperture, a first patch connected to the first layer, the first patch extending across and covering the first aperture, and having an exterior face facing the second inflatable bladder, and a second patch connected to the second layer, the second patch extending across and covering the second aperture, and having an exterior face facing the first inflatable bladder. The exterior face of the first patch is connected to the exterior face of the second patch at a patch connection thereby connecting the first inflatable bladder to the second inflatable bladder.

### BRIEF DESCRIPTION OF THE DRAWINGS

Having thus generally described the nature of the present technology, reference will now be made to the accompanying drawings, showing by way of illustration example embodiments thereof and in which:

FIG. 1 is a perspective view, taken from a top, front, left side of an exemplary support surface for a patient support apparatus according to an embodiment of the present technology;

FIG. 2 is a perspective view, taken from a top, rear, left side of the support surface of FIG. 1, with part of the top cover removed to show different components of a core of the support surface;

FIG. 3 is a perspective view, taken from a top, rear, right side of an inflatable bladder assembly of the support surface of FIG. 1, without casing;

FIG. 4 is a front view of the inflatable bladder assembly of FIG. 3;

FIG. 5 is a cross-sectional view of the inflatable bladder assembly of FIG. 3, taken through cross-section line 5-5 of FIG. 4;

FIG. 6 is an enlarged view of portion 6 of the inflatable bladder assembly of FIG. 5;

FIG. 7 is an exploded, perspective view taken from a top, rear, right side of the inflatable bladder assembly of FIG. 3, with the flexible layers forming each of the inflatable bladders and with the casing laid flat and unfolded;

FIG. 8 is an exploded, perspective view taken from a bottom, rear, right side of the inflatable bladder assembly of FIG. 7;

FIG. 9 is an exploded, perspective view taken from a top, rear, right side of another embodiment of an inflatable bladder assembly of the support surface of FIG. 1, with the flexible layers forming each of the inflatable bladders and portions of anchor strips laid flat and unfolded;

FIG. 10 is a top plan view of the inflatable bladder assembly of FIG. 9, with each of the P&V bladders connected to the corresponding portion of anchor strips;

FIG. 11 is a flowchart of a method for forming an inflatable bladder assembly in accordance with an embodiment of the present technology;

FIG. 12 is a top view of unfolded, flexible blanks used to form each inflatable bladder of the inflatable bladder assembly of FIG. 3;

FIG. 13 is a top view of the flexible blanks of FIG. 10, with the flexible blanks of the P&V bladders located on top of and connected to the flexible blank of the comfort bladder;

FIG. 14 is a top view of the flexible blanks of FIG. 11, with the flexible blanks of the P&V bladders folded and with corresponding edges coupled in an airtight manner; and

FIG. 15 is a top view of the flexible blanks of FIG. 12, with the flexible blank of the comfort bladder folded and with corresponding edges coupled in an airtight manner.

It will be noted that throughout the appended drawings, like features are identified by like reference numerals. To not unduly encumber the figures, some elements may not be indicated in some figures if they were already identified in a preceding figure. It should be understood herein that elements of the drawings are not necessarily depicted to scale. Some mechanical or other physical components may also be omitted in order to not encumber the figures.

### DETAILED DESCRIPTION

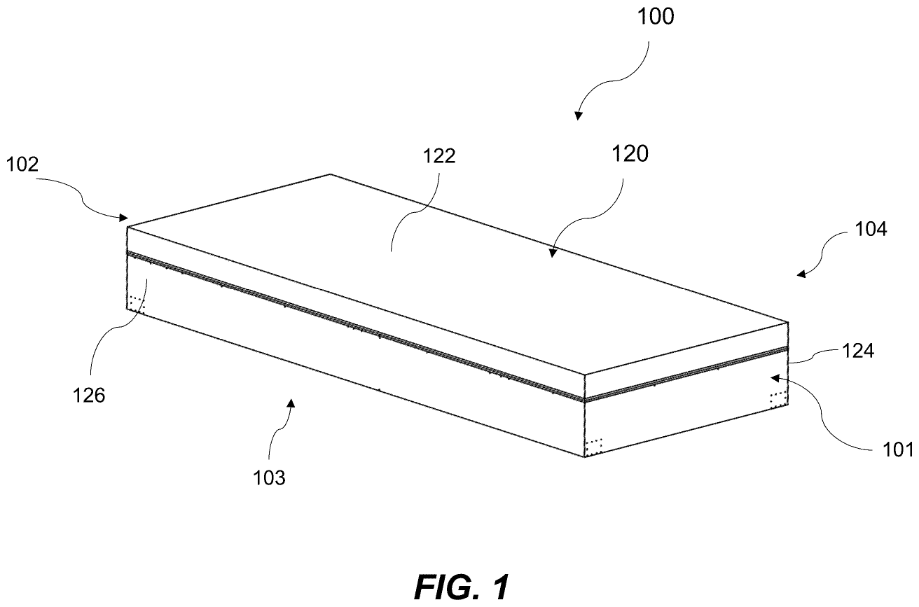

Generally described, the present technology relates to the connection of inflatable bladders to one another to form an inflatable bladder assembly in a support surface. In view of the context of the present technology and referring to FIG. 1, a mattress 100 will be described herein. The mattress 100 may be used in a medical setting for supporting a patient. The mattress 100 may alternatively be referred to as a “support surface”. The mattress 100 is usable in combination with a patient support apparatus, such as a hospital bed in an intensive care unit (ICU) setting. It is contemplated that, in other embodiments, the patient support apparatus may be a different type of patient support apparatus such as, for example, a stretcher, a motorized chair, an operating room table, or other specialty tables (e.g., an examination table) and in other medical environments such as in medical-surgical (med-surg) care or long-term care units.

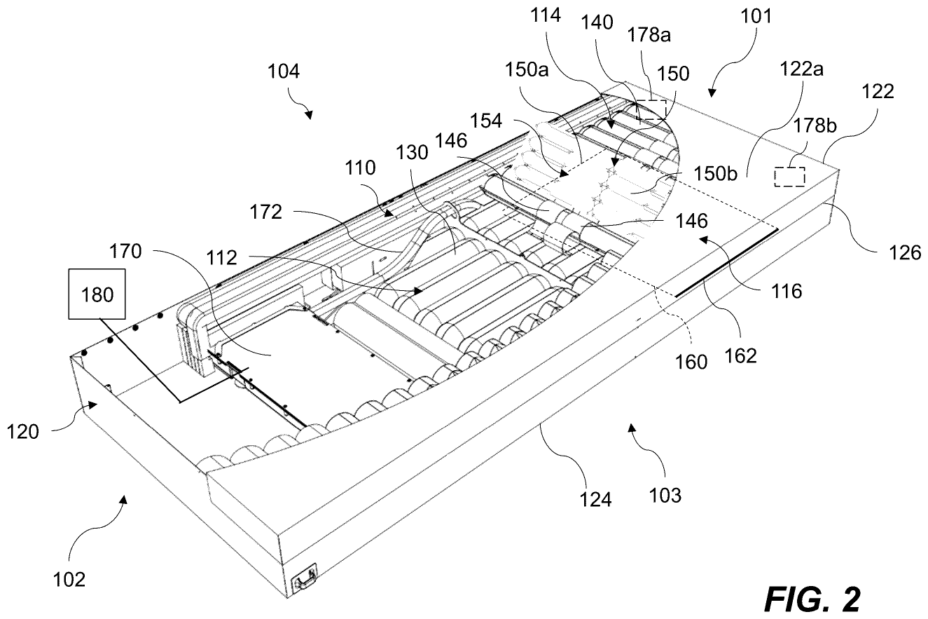

Referring to FIG. 1, the mattress 100 has a head end 101 and a foot end 102 opposite the head end 101. The mattress 100 also has opposite lateral sides 103, 104 extending from the head end 101 to the foot end 102. Referring to FIGS. 1 and 2, the mattress 100 has a core 110 (FIG. 2) and a cover 120 enclosing the core 110. The cover 120 includes a top cover 122 and a base cover 124 connected to one another via a zipper 126 to enclose the core 110. The core 110 provides support for the patient and may include pneumatic layers, foam layers, or a combination of both.

Referring to FIG. 2, the core 110 includes a support layer 112 and a comfort layer 114 disposed above the support layer 112. The support layer 112 provides a firm base for the core 110 while the comfort layer 114 is in more direct contact with a patient lying on the mattress 100 when in use as it is closer to a top surface 122a of the top cover 122. Together, both layers 112, 114 support the patient on the mattress 100. It is contemplated that, in some embodiments, only one of the layers 112, 114 may be provided.

Still referring to FIG. 2, the support layer 112 includes a plurality of inflatable support bladders 130. The inflatable support bladders 130 are longitudinally oriented (i.e., they extend in a longitudinal direction of the mattress 100). The inflatable support bladders 130 could be oriented differently in other embodiments.

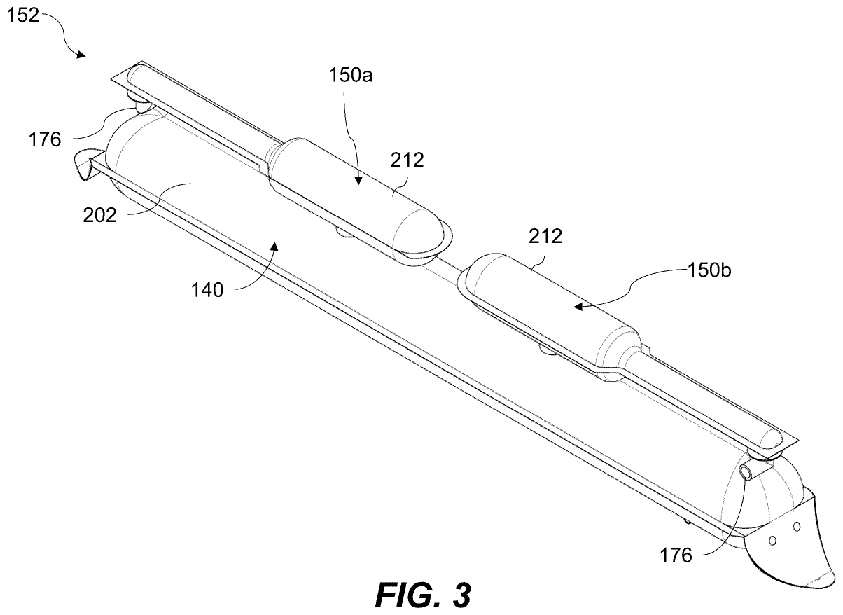

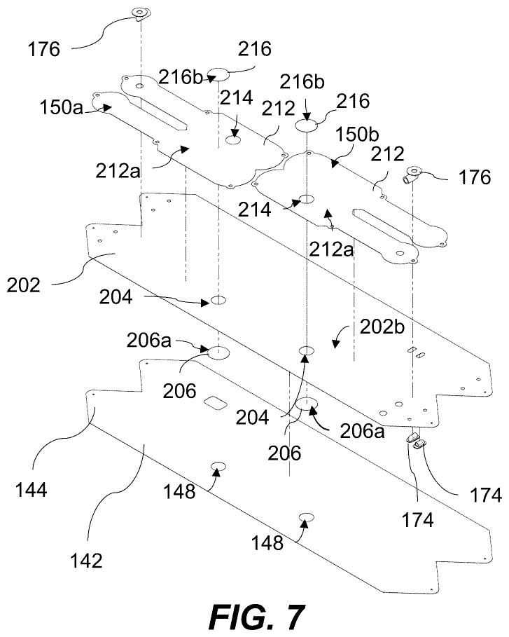

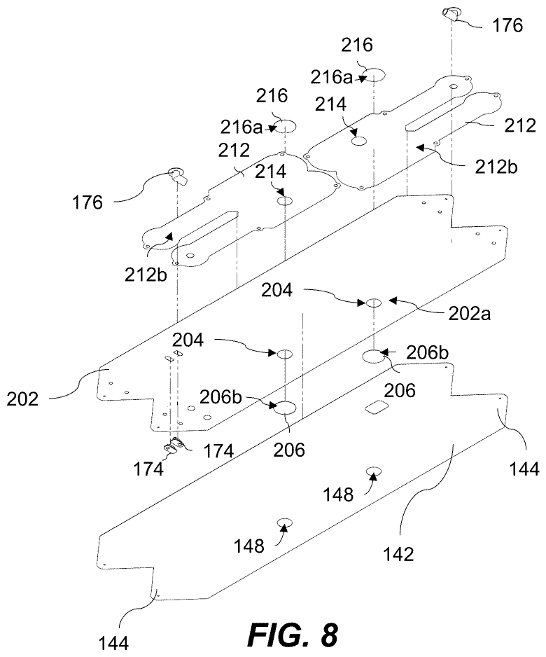

Referring to FIGS. 2 and 3, the comfort layer 114 includes a plurality of inflatable comfort bladders 140 that can be selectively inflated and deflated. In this example, the comfort bladders 140 are transversally oriented (i.e., they extend in a transversal direction across the width of the mattress 100). It is contemplated that the inflatable comfort bladders 140 could be oriented differently in other embodiments. The inflatable comfort bladders 140 have a generally cylindrical shape, but other shapes may be used. In this embodiment, the inflatable comfort bladders 140 are mounted together side by side in a longitudinal direction of the mattress 100. The inflatable comfort bladders 140 extend transversally across the width of the mattress 100 between the lateral sides 103, 104. Moreover, a casing 142 (best seen in FIGS. 7 and 8) encloses each one of the inflatable comfort bladders 140. In the present embodiment, the casing 142 is made of a material that is different from the material of the inflatable comfort bladders 140. The casing 142 includes tabs 144 (FIG. 7) for removable connection to anchor points provided in the core 110. It is thus contemplated that each inflatable comfort bladder 140 enclosed in its respective casing 142 can be removed and replaced in the support surface 100 if needed. The core 110 further includes anchor strips 146 extending longitudinally between the head end 101 and the foot end 102. The anchor strips 146 are secured to anchor points within the core 110. The anchor strips 146 define loops through which the inflatable comfort bladders 140 extend transversally. Other configurations of the anchor strips 146 are contemplated. In some embodiments, the anchor strips 146 assist in maintaining the inflatable comfort bladders 140 in a close side-by-side relationship, and thus limit the spacing that can appear between adjacent inflatable comfort bladders 140 when a patient is lying and/or moving on the support surface 100.

Still referring to FIGS. 2 and 3, the support surface 100 further includes inflatable percussion and vibration (P&V) bladders 150 located above some of the inflatable comfort bladders 140 included in a chest section 116 of the comfort layer 114 that is located closer to the head end 101 than to the foot end 102. The P&V bladders 150 include left and right P&V bladders 150a, 150b, i.e. corresponding to each of the patient's lungs. Together, the P&V bladders 150a, 150b and the inflatable comfort bladder 140 on which they are located form an inflatable bladder assembly 152, as shown in FIG. 3, which can be removed from the core 110 of the support surface 100 and replaced if needed. The P&V bladders 150 are located vertically between the top surface 122a of the top cover 122, and the comfort bladders 140 forming the comfort layer 114. The P&V bladders 150 are part of a P&V bladder system 154 (FIG. 2) configured to provide percussion and vibration therapy to a patient lying on the support surface 100. The P&V bladder system 154 includes a plurality of the P&V bladders 150 located adjacent to one another in a longitudinal direction of the mattress 100. As will be described further below, percussion and vibration therapy involves, in some instances, rapidly inflating and deflating the P&V bladders 150 bladders to create pulsations and vibrations which may assist in, for example and not limited to, reducing the accumulation of fluids in a patient's lungs and stimulating blood flow.

The mattress 100 further includes a pocket 160 (schematically shown in dashed lines) configured to receive a chest X-ray plate (not shown) therein. The pocket 160 is accessible through an opening 162 at a side of the cover 120 of the support surface 100. Optionally, a zipper may be coupled to the cover 120 and may be configured to open and close the opening 162.

Referring to FIG. 2, in order to control the inflation and deflation of the bladders 130, 140, 150, the mattress 100 includes a pneumatic control assembly 170 fluidly connected to the bladders 130, 140, 150 and to other components of the mattress 100. The pneumatic control assembly 170 controls air flow to the various air-powered components of the mattress 100. The pneumatic control assembly 170 may include blowers, compressors, pumps, valves, manifolds or a combination of any one of these components. The pneumatic control assembly 170 enables the mattress 100 to provide a range of therapeutic functionalities.

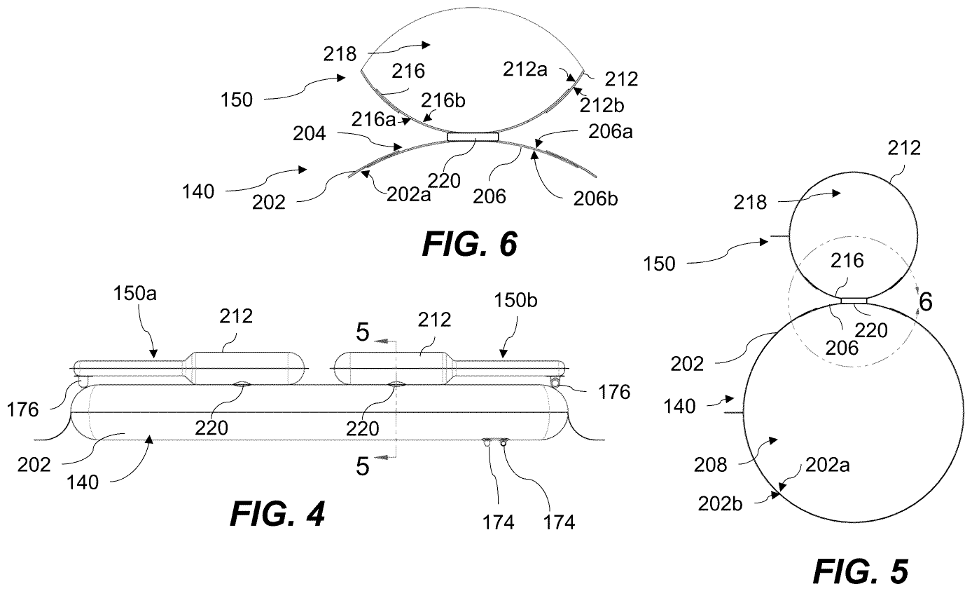

Still referring to FIG. 2, the pneumatic control assembly 170 is enclosed within the mattress cover 120 and is disposed underneath the support layer 112 near the foot end 102. The pneumatic control assembly 170 could be located elsewhere in the mattress 100 in other embodiments. In some embodiments, the pneumatic control assembly 170 could be located externally to the mattress 100, for example in a separate unit that can be located next to the mattress 100 (e.g., hung at a footboard of the patient support apparatus). A plurality of air tubes 172 (two of which are shown in FIG. 2) fluidly connects the pneumatic control assembly 170 to the inflatable support bladders 130, the inflatable comfort bladders 140 and the P&V bladders 150. More particularly, the pneumatic control assembly 170 is fluidly connected to each of the inflatable comfort bladders 140 through a corresponding air tube 172 and via bagports 174 (FIG. 4) connected to each of the inflatable comfort bladders 140. The pneumatic control assembly 170 is fluidly connected to the P&V bladders 150 through a control box 178a (schematically shown in FIG. 2) fluidly connected to the left P&V bladders 150a via a set of air tubes 172, and through a control box 178b (schematically shown in FIG. 2) fluidly connected to the right P&V bladders 150b via another set of air tubes 172. In some embodiments, the pneumatic control assembly 170 supplies air through the air tubes 172 and the control boxes 178a, 178b include valves movable to selectively inflate or deflate the corresponding P&V bladders 150. The air tubes 172 connect to each of the P&V bladders 150 at bagports 176 connected thereto. The bagports 174, 176 are used to allow air to flow into and out of the corresponding bladders 140, 150. It is contemplated that the air tubes 172 could also connect the pneumatic control assembly 170 to any other pneumatic element (not shown) of the mattress 100.

In the illustrated embodiment, the pneumatic control assembly 170 is operatively connected to a control unit 180 (schematically illustrated in FIG. 2) and associated user interface (not shown) that are integrated into the patient support apparatus to operate and control the mattress 100 as desired. The user interface for the control unit 180 can be a touchscreen display, allowing healthcare providers to easily adjust settings related to the inflation and deflation of the inflatable bladders 130, 140, 150. For instance, the user interface for the control unit 180 can allow the healthcare providers to inflate and deflate the bladders 130, 140, 150 in a controlled manner. The control unit 180 includes a microprocessor that manages the operation of the inflatable bladders 130, 140, 150 based on pre-set programs or manual adjustments such as intensity, frequency, and duration of the therapy. In addition, in some embodiments, the control unit 180 is programmed to perform the vibration therapy automatically after the percussion therapy is completed.

The inflatable bladders 130, 140, 150 are regrouped into distinct pneumatic control zones. The pneumatic control assembly 170 and the control unit 180 are operable to selectively inflate or deflate independently each of the different pneumatic control zones. More particularly, some of the inflatable comfort bladders 140 can be regrouped into a pneumatic control zone, while other inflatable comfort bladders 140 can be regrouped into another pneumatic control zone. The P&V bladders 150 can be regrouped into a pneumatic control zone that is distinct from the pneumatic control zone of the inflatable comfort bladders 140. Furthermore, in some embodiments, in the inflatable bladder assemblies 152, the left P&V bladders 150a can be part of a pneumatic control zone distinct from a pneumatic control zone of the right P&V bladders 150b.

To perform percussion or vibration therapy, the pneumatic control assembly 170 and the control unit 180 are operated to provide air pulses or oscillations sent through the air tubes 172 to the P&V inflatable bladders 150 to provide the pulmonary percussion and vibration therapies. In one embodiment, the control unit 180 and the pneumatic control assembly 170 can cause the P&V bladders 150 to inflate or deflate so as to have a frequency of vibrations ranging between 9 and 30 Hz, while the percussion can be adjusted to have a frequency ranging from 1 to 8.5 Hz. Other frequencies are contemplated. In one example of vibration therapy, the right P&V bladders 150b inflate while the left P&V bladders 150a deflate, and vice-versa, and each of the P&V bladders 150 a, 150 b undergo the inflate-deflate cycle at a frequency of 15 Hz. The control unit 180 and the pneumatic control assembly 170 can also provide for different levels of intensity, for example, low, mid and high. The pneumatic control assembly 170 is also operable to maintain an air pressure within the inflatable comfort bladders 140 while the air pressure within the P&V bladders 150 varies over time when percussion or vibration therapy is performed. In some embodiments, the air flow and the air pressure within the P&V bladders 150 vary as a function of the level of intensity. Additionally, the pneumatic control assembly 170 is also operable to maintain an air pressure within the inflatable support bladders 130 while the air pressure within the P&V bladders 150 varies over time when percussion or vibration therapy is performed. By having the inflatable support bladders 130 and/or the inflatable comfort bladders 140 inflated at a relatively high pressure when performing percussion and vibration therapy, the bladders 130, 140 have enhanced rigidity beneath the P&V bladders 150, thereby enhancing the effectiveness of the P&V therapy to loosen and/or dislodge mucus from the patient's lungs. In some embodiments, the pneumatic control assembly 170 and the control boxes 178a, 178b are operated to perform percussion and vibration therapy with the left P&V bladders 150a, the right P&V bladders 150b, the left and right P&V bladders 150a, 150b in alternance, or the left and right P&V bladders 150a, 150b simultaneously. The control unit 180, together with the pneumatic control assembly 170, is also operable to conduct the percussion therapy for a pre-determined amount of time, and to conduct the vibration therapy for a pre-determined amount of time. In one example, percussion therapy is conducted for 5, 10 or 15 minutes, and when time is up, vibration therapy is conducted for 5, 10 or 15 minutes. Other pre-determined amounts of time are contemplated. The therapies can further be stopped by healthcare providers via the graphical user interface. When pulmonary pulsation therapy is not performed on the patient, the P&V inflatable bladders 150 are deflated to a substantially flat configuration.

In the following section of the description, the connection between the inflatable comfort bladders 140 and the left and right P&V bladders 150a, 150b, collectively referred to as the P&V bladders 150, will be described. For the sake of clarity, the connection of the left P&V bladder 150a to the comfort bladder 140 is identical to the connection of the right P&V bladder 150b to the comfort bladder 140, and therefore their features are identified with the same reference numerals in the accompanying drawings.

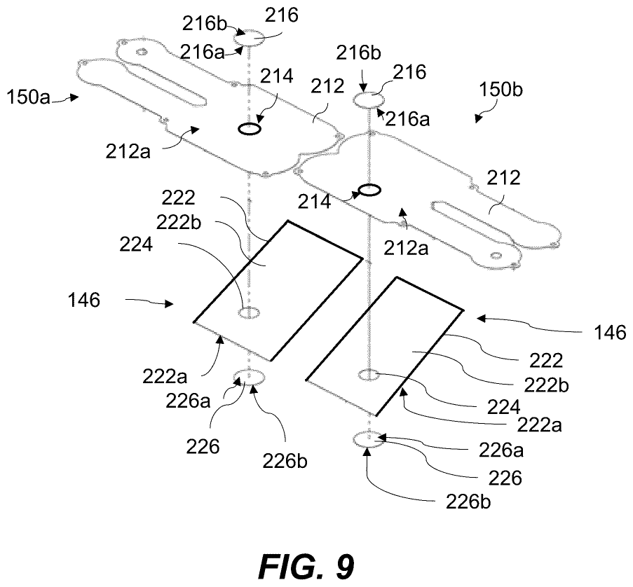

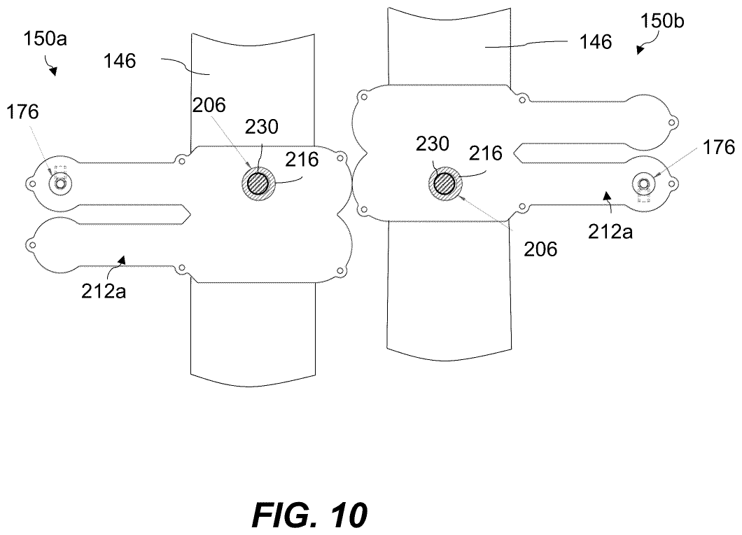

However, the present technology is not limited to the connection between the comfort bladder 140 and the P&V bladders 150. The technology relates to the connection between an inflatable bladder, such as any one of the support bladders 130, the comfort bladders 140 and the P&V bladders 150, to a support located adjacent the inflatable bladder within the core 110. As an additional exemplary embodiment shown in FIGS. 9 and 10, the technology will be described further below in relation to the connection between the P&V bladders 150 and the anchor strips 146 located within the core 110. In other words, in the embodiment described in relation to FIGS. 3 to 8, the support is an inflatable comfort bladder 140, while in the embodiment described in relation to FIGS. 9 and 10, the support is one of the anchor strips 146. The present technology could also apply to the connection of, for example, one of the inflatable support bladders 130 to one of the inflatable comfort bladders 140, where the inflatable support bladder 130 supports the inflatable comfort bladder 140. Moreover, the present technology could apply to the connection between two adjacent inflatable comfort bladders 140, or two adjacent inflatable support bladders 130, where one of the inflatable bladders acts as a support for the other.

The present technology advantageously allows for a secure connection of an inflatable bladder to a support within the core 110 while reducing the X-ray imagery artifacts generated by the presence of such connection. In addition, the present technology allows for a secure connection between an inflatable bladder and an adjacent support ensuring seamless integration and, at least in some circumstances, improved comfort for the patient.

Turning now to FIGS. 3 to 8, the inflatable comfort bladder 140 includes an air impermeable layer 202 defining an aperture 204, best seen in FIGS. 7 and 8. The aperture 204 is round, but the aperture 204 could be shaped otherwise in other embodiments. The air impermeable layer 202 is made of a specialized fabric that has stretch characteristics suitable for improving comfort of a patient. For instance, the layer 202 is made of a nylon-based, 4-way stretch fabric. Other fabrics are contemplated in other embodiments. The layer 202 has an interior face 202a facing inside the air chamber 208 (FIG. 5) defined by the inflatable comfort bladder 140, and an exterior face 202b opposite to the interior face 202a. The interior face 202a includes a radiofrequency (RF)-weld compatible material, such as a polyurethane based material or polyvinyl chloride (PVC) based material, which may promote the air-impermeability of the layer 202. In the present embodiment, the exterior face 202b does not include a RF-weld compatible material, such as a polyurethane-based material or a PVC-based material.

A patch 206, best seen in FIGS. 6 to 8, is connected to the layer 202. The patch 206 is connected to the interior face 202a of the layer 202, but the patch 206 could be connected to the exterior face 202b in other embodiments. The material of the patch 206 is identical to the material forming the air impermeable layer 202, but the patch 206 could be made of a different material in other embodiments. The patch 206 has an exterior face 206a (FIGS. 6 and 7) and an opposite interior face 206b (FIGS. 6 and 8) facing the inside of the air chamber 208 defined by the inflatable comfort bladder 140. In the present embodiment, the patch 206 is made from a swatch of the material forming the layer 202, turned upside-down and connected to the interior face 202a of the layer 202 such that the patch 206 extends across and covers the aperture 204, leaving a portion of the exterior face 206a facing the P&V bladder 150. Put differently, the exterior face 206a includes a RF-weld compatible material, such as a polyurethane-based material or a PVC-based material, and corresponds to the interior face 202a of the layer 202, and the interior face 206b does not include a RF-weld compatible material, such as a polyurethane-based material or a PVC-based material, and corresponds to the exterior face 202b of the layer 202. The patch 206 is connected to the layer 202 using radiofrequency welding techniques during which the RF-weld compatible material of the interior face 202a of the layer 202 bonds with the RF-weld compatible material of the exterior face 206a of the patch 206 to form an airtight seal between the patch 206 and the layer 202. The patch 206 could be connected otherwise in other embodiments using different techniques suitable for providing airtight connection with the layer 202, for example heat sealing, adhesive, etc. Since the interior face 206b does not include RF-weld compatible material, the interior face 206b is incompatible for RF-welding with the interior face 202a of the layer 202.

Still referring to FIGS. 3 to 8, each of the P&V bladders 150 includes an air impermeable layer 212 defining an aperture 214. The aperture 214 is round, but could be shaped otherwise in other embodiments. The air impermeable layer 212 is made of a material that has characteristics, such as durability and resistance to cleaning agents, suitable for P&V therapy. For instance, the air impermeable layer 212 is made of a non-stretch fabric, in the sense that the fabric does not stretch significantly when strained. The layer 212 has an interior face 212a (FIGS. 6 and 7) facing inside the air chamber 218 defined by the P&V bladder 150, and an exterior face 212b (FIGS. 6 and 8). The interior face 212a includes a RF-weld compatible material, such as a polyurethane-based material or a PVC-based material, which may promote the air-impermeability of the layer 212. The exterior face 212b does not include a RF-weld compatible material, such as a polyurethane-based material or a PVC-based material. A patch 216 is connected to the layer 212. The patch 216 is connected to the interior face 212a of the layer 212, but could be connected to the exterior face 212b in other embodiments. In the present embodiment, the material of the patch 216 is identical to the material forming the air impermeable layer 212, but could be made of a different material in other embodiments. The patch 216 has an exterior face 216a (FIGS. 6 and 8) and an opposite interior face 216b (FIGS. 6 and 7) facing the inside of the air chamber 218 defined by the inflatable P&V bladder 150. In the present embodiment, the patch 216 is made from a swatch of the material forming the layer 212, turned upside-down and connected to the interior face 212a of the layer 212 such that the patch 216 extends across and covers the aperture 214, leaving a portion of the exterior face 216a facing the comfort bladder 140. Put differently, the exterior face 216a includes RF-weld compatible material and corresponds to the interior face 212a of the layer 212, and the interior face 216b does not include RF-weld compatible material and corresponds to the exterior face 212b. The patch 216 is connected to the layer 212 using RF-welding techniques during which the RF-weld compatible material of the interior face 212a of the layer 212 bonds with the RF-weld compatible material of the exterior face 216a of the patch 216 to form an airtight seal between the patch 216 and the layer 212. The patch 216 could be connected otherwise in other embodiments using different techniques suitable for providing airtight connection with the layer 212, for example heat sealing, adhesive, etc.

The exterior face 206a of the patch 206 is connected to the exterior face 216a of the patch 216 at a patch connection 220, thereby connecting the comfort bladder 140 to the P&V bladder 150. The patch connection 220 is schematic and not to scale in FIGS. 6 and 8. The patch connection 220 between the exterior faces 206a, 216a is made using RF-welding techniques during which the RF-weld compatible material of the exterior face 206a of the patch 206 bonds with the RF-weld compatible material of the exterior face 216a of the patch 216. The patch connection 220 could be made otherwise in other embodiments. It is to be noted that the casing 142 defines a casing aperture 148 (FIGS. 7 and 8) surrounding the patches 206, 216. The casing aperture 148 is shaped and dimensioned to allow for the patch connection 220 between the inflatable comfort bladder 140 to the P&V bladder 150 notwithstanding the presence of the casing 142 therebetween. In some embodiments, the casing 142 is omitted and the layer 202 of the inflatable comfort bladder 140 is made of a nylon-based, 2-way stretch material. Other materials are contemplated in other embodiments.

The patch connection 220 between the inflatable comfort bladder 140 and the P&V bladder 150 provided by the patches 206, 216 and the RF-welds may assist in reducing the imagery artifacts obtained during X-Ray radiography of the torso of a patient lying on the support surface 100, since the materials forming the comfort bladder 140, the P&V bladder 150, the patches 206, 216 and the patch connection 220 have similar densities, they reduce the amount of imagery artifacts obtained during radiography. Moreover, since the materials forming the layer 202 of the comfort bladder 140 and the patch 206 are identical, and since the materials forming the layer 212 of the P&V bladder 150 and the patch 216 are identical, there is continuity in the materials properties of each of the bladders 140, 150 which enhance their integration in the inflatable bladder assembly 152 and, at least in some cases, improves the comfort of the patient lying on the support surface 100.

Turning now to FIGS. 9 and 10, the present technology is illustrated with regards to the connection between the P&V bladders 150 and adjacent portions of the anchor strips 146. Each anchor strips 146 includes a layer 222 defining an aperture 224, best seen in FIG. 9. The aperture 224 is round, but could be shaped otherwise in other embodiments. The layer 222 has an interior face 222a facing towards the core 110 of the support surface 100, and an exterior face 222b opposite the interior face 222a facing towards the P&V bladders 150. The interior face 222a includes a radiofrequency (RF)-weld compatible material, such as a polyurethane based material or polyvinyl chloride (PVC) based material. In the present embodiment, the exterior face 222b does not include a RF-weld compatible material, such as a polyurethane-based material or a PVC-based material.

A patch 226, best seen in FIG. 9, is connected to the layer 222. The patch 226 is connected to the interior face 222a of the layer 222, but the patch 226 could be connected to the exterior face 222b in other embodiments. The material of the patch 226 is identical to the material forming the layer 222, but the patch 226 could be made of a different material in other embodiments. The patch 226 has an exterior face 226a (FIG. 9) facing the P&V bladders 150 and an opposite interior face 226b facing the core 110. In the present embodiment, the patch 226 is made from a swatch of the material forming the layer 222, turned upside-down and connected to the interior face 222a of the layer 222 such that the patch 226 extends across and covers the aperture 224, leaving a portion of the exterior face 226a facing the P&V bladder 150. Put differently, the exterior face 226a includes a RF-weld compatible material, such as a polyurethane-based material or a PVC-based material, and corresponds to the interior face 222a of the layer 222, and the interior face 226b does not include a RF-weld compatible material, such as a polyurethane-based material or a PVC-based material, and corresponds to the exterior face 222b of the layer 222. The patch 226 is connected to the layer 222 using radiofrequency welding techniques during which the RF-weld compatible material of the interior face 222a of the layer 222 bonds with the RF-weld compatible material of the exterior face 226a of the patch 226 to form a seal between the patch 226 and the layer 222. The patch 226 could be connected otherwise in other embodiments using different techniques suitable for providing secure connection with the layer 222, for example heat sealing, adhesive, etc. Since the interior face 226b does not include RF-weld compatible material, the interior face 226b is incompatible for RF-welding with the interior face 222a of the layer 222.

Still referring to FIGS. 9 and 10, each of the P&V bladders 150 includes an air impermeable layer 212 defining an aperture 214. The aperture 214 is round, but could be shaped otherwise in other embodiments. The air impermeable layer 212 is made of a material that has characteristics, such as durability and resistance to cleaning agents, suitable for P&V therapy. The layer 212 has an interior face 212a facing inside the air chamber 218 defined by the P&V bladder 150, and an exterior face 212b (best seen in FIGS. 6 and 8). A patch 216 is connected to the layer 212. The patch 216 is connected to the interior face 212a of the layer 212, but could be connected to the exterior face 212b in other embodiments. In the present embodiment, the material of the patch 216 is identical to the material forming the air impermeable layer 212, but could be made of a different material in other embodiments. The patch 216 has an exterior face 216a and an opposite interior face 216b facing the inside of the air chamber 218 defined by the inflatable P&V bladder 150. In the present embodiment, the patch 216 is made from a swatch of the material forming the layer 212, turned upside-down and connected to the interior face 212a of the layer 212 such that the patch 216 extends across and covers the aperture 214, leaving a portion of the exterior face 216a facing the anchor strip 146. Put differently, the exterior face 216a includes RF-weld compatible material and corresponds to the interior face 212a of the layer 212, and the interior face 216b does not include RF-weld compatible material and corresponds to the exterior face 212b. The patch 216 is connected to the layer 212 using RF-welding techniques during which the RF-weld compatible material of the interior face 212a of the layer 212 bonds with the RF-weld compatible material of the exterior face 216a of the patch 216 to form an airtight seal between the patch 216 and the layer 212. The patch 216 could be connected otherwise in other embodiments using different techniques suitable for providing airtight connection with the layer 212, for example heat sealing, adhesive, etc.

The exterior face 226a of the patch 226 is connected to the exterior face 216a of the patch 216 at a patch connection 230, thereby connecting the anchor strip 146 to the P&V bladder 150. The patch connection 230 between the exterior faces 216a, 226a is made using RF-welding techniques during which the RF-weld compatible material of the exterior face 216a of the patch 216 bonds with the RF-weld compatible material of the exterior face 226a of the patch 226. The patch connection 230 could be made otherwise in other embodiments.

The patch connection 230 between the anchor strip 146 and the P&V bladder 150 provided by the patches 216, 226 and the RF-welds may assist in reducing the imagery artifacts obtained during X-Ray radiography of the torso of a patient lying on the support surface 100, since the materials forming the anchor strip 146, the P&V bladder 150, the patches 216, 226 and the patch connection 230 have similar densities, they reduce the amount of imagery artifacts obtained during radiography. Moreover, since the materials forming the layer 222 of the anchor strip 146 and the patch 226 are identical, and since the materials forming the layer 212 of the P&V bladder 150 and the patch 216 are identical, there is continuity in the materials properties which enhance their integration in the core 110 and, at least in some cases, improves the comfort of the patient lying on the support surface 100.

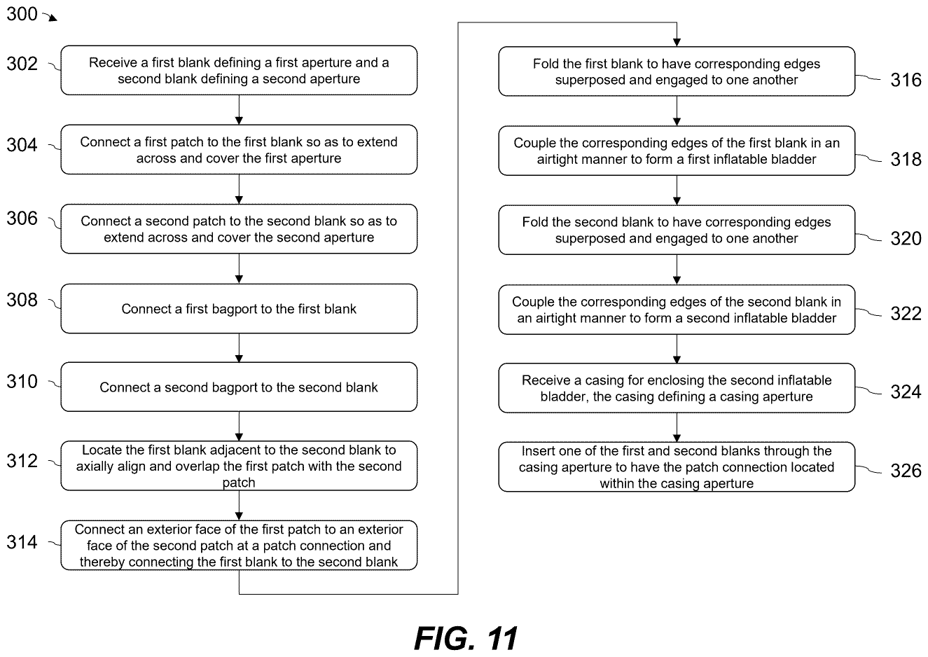

Turning now to FIGS. 11 to 15, a method 300 for forming the inflatable bladder assembly 152 for the inflatable support surface 100 will be described. The method 300 is described in relation with the embodiment of the inflatable bladder assembly 152 shown in FIGS. 3 to 8, but adaptations related to generalisation of the method 300 to other embodiments, such as the embodiment shown in FIGS. 9 and 10, will also be described.

At step 302, and with reference to FIGS. 7, 8 and 12, air impermeable flexible blanks 202′, 212′ for forming the layers 202, 212 of the inflatable comfort bladder 140, the left P&V bladder 150a, and the right P&V bladder 150b are received. The blank 202′ defines two apertures 204, and each of the blanks 212′ define one aperture 214. With reference to FIGS. 9 and 10, the blanks correspond to the blanks for forming the layers 212 of the P&V bladders 150a, 150b, and the corresponding portion of the anchor strip 146.

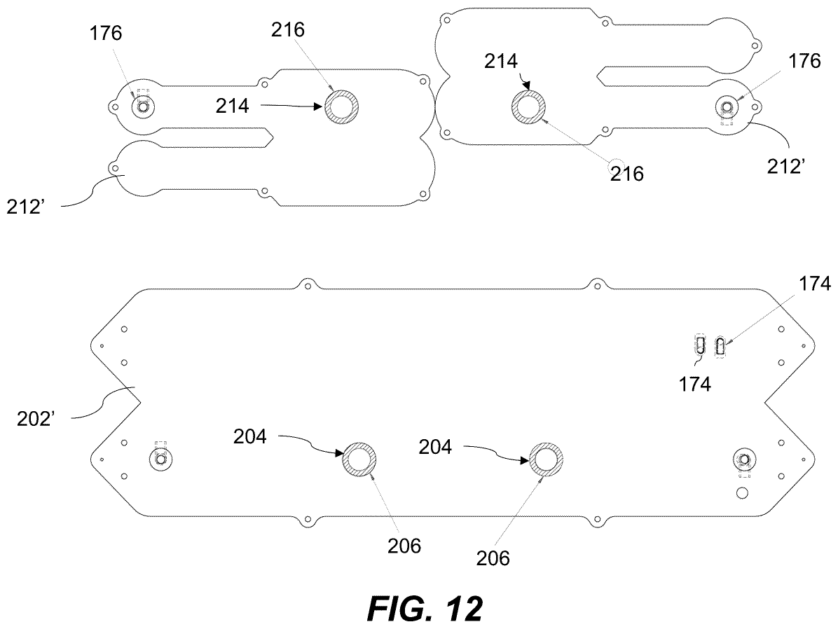

At step 304, and with reference to FIGS. 7, 8 and 12, two patches 206 are connected through RF-welding to the interior face 202a of the blank 202′ so as to extend across and cover their corresponding apertures 204. The connection of each patch 206 is shown in hatching in FIG. 12. As described above, the exterior face 206a of each patch 206 is connected the interior face 202a of the blank 202′. With reference to FIGS. 9 and 10, the patches 226 are connected through RF-welding to the interior face 222a of the blank corresponding to the portion of anchor strip 146, so that the patches 226 extend across and cover the aperture 224.

At step 306, and with references to FIGS. 7, 8 and 12, a patch 216 is connected through RF-welding through the interior face 212a of each blank 212′ so as to extend across and cover their corresponding aperture 214. The connection of each patch 216 is shown in hatching in FIG. 12. As described above, the exterior face 216a of each patch 216 is connected the interior face 212a of the blank 212′. Step 306 is performed similarly in the embodiment shown in FIGS. 9 and 10. The connection of each patch 216 is also shown in hatching in FIG. 10.

At step 308, the bagports 174 are inserted into holes formed in the blank 202′, and the bagports 174 are connected to the blank 202′ in an airtight manner.

At step 310, the bagports 176 are inserted into holes formed in the blanks 212′, and the bagports 176 are connected to the blanks 212′ in an airtight manner.

At step 312, and with reference to FIGS. 7, 8 and 13, the blanks 212′ are located on top of the blank 202′ to axially align and overlap the patches 216 with corresponding patches 206. With reference to FIG. 9, the layers 212 are located on top of the layers 222 to axially align and overlap the patches 216 with the corresponding patches 226.

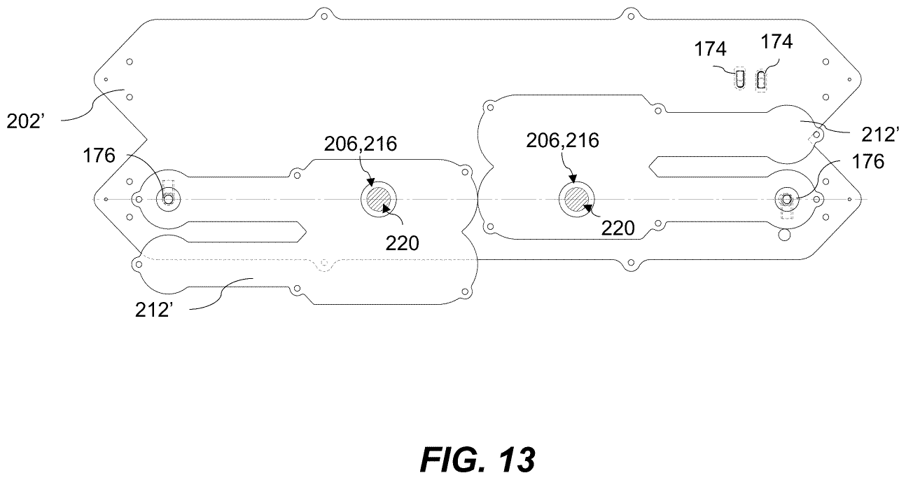

At step 314, and with reference to FIG. 13, the blanks 212′ are aligned parallel to the blank 202′, and the exterior face 206a of each patch 206 is RF-welded to the exterior face 216a of corresponding patch 216 for forming corresponding patch connections 220, thereby connecting the blanks 212′ to the blank 202′. The patch connections 220 are shown in hatching in FIG. 13. With reference to FIGS. 9 and 10, the exterior face 226a of each patch 226 is RF-welded to the exterior face 216a of corresponding patch 216 for forming patch connections 230 shown in hatching in FIG. 10, thereby connecting the layer 212 of each P&V bladder 150 to the corresponding portion of anchor strip 146.

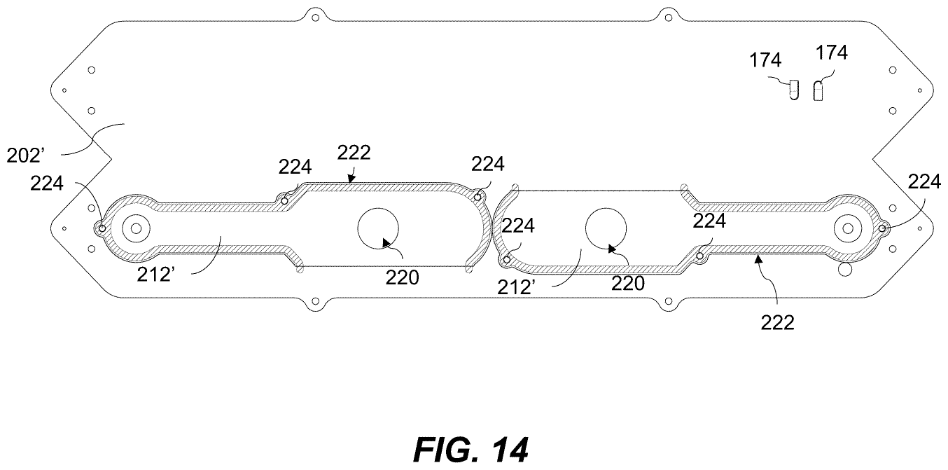

At step 316, and with reference to FIG. 14, the blanks 212′ are folded to have corresponding edges 222 superposed and engaged to one another. To assist in this step, index holes 224 defined in the edges 222 are axially aligned and overlapped.

At step 318, and still referring to FIG. 14, the edges 222 are coupled in an airtight manner to form the P&V bladders 150. The coupling is shown in hatching in FIG. 14. The step 316 can be performed using RF-welding, or any other suitable technique.

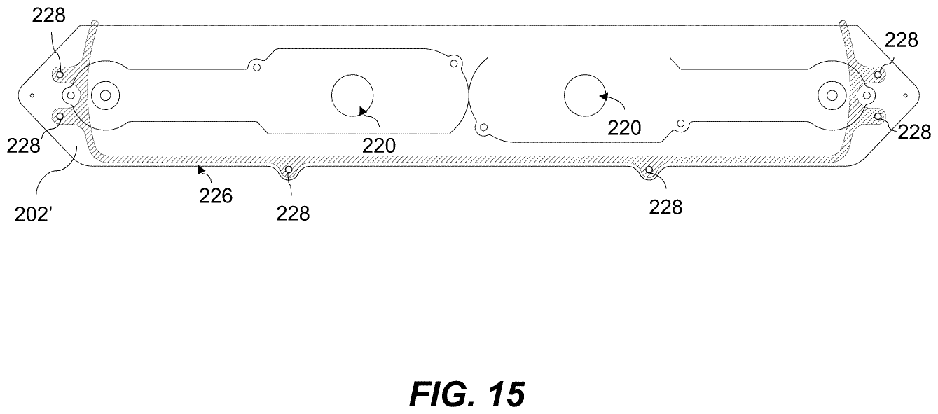

At step 320, and with reference to FIG. 15, the blank 202′ is folded to have corresponding edges 226 superposed and engaged to one another. To assist in this step, index holes 228 defined in the edges 226 are axially aligned and overlapped.

At step 322, and still referring to FIG. 15, the edges 226 are coupled in an airtight manner to form the inflatable comfort bladder 140. The coupling is shown in hatching in FIG. 13. The step 320 can be performed using RF-welding, or any other suitable technique.

Steps 320 and 324 are not performed in the method forming the embodiment shown in FIGS. 9 and 10 as the anchor strips 146 do not need to be folded and coupled as just described.

At step 324, the casing 142 (FIGS. 7 and 8) is received with the casing apertures 148 defined therein.

At step 326, the blank 202′ is inserted in the casing 142 and the two patch connections 220 are located within the casing apertures 148. In one embodiment, the blanks 212′ are folded, inserted into the casing apertures 148 and unfolded after passing through the casing apertures 148, thus leaving the inflatable comfort bladder 140 located inside the casing 142 while having the P&V bladders 150 located outside the casing 142, and with the patch connections 220 located within the casing apertures 148.

The embodiments described above are intended to be exemplary only. The scope of the invention is therefore intended to be limited solely by the appended claims.

1.-20. (canceled)

21. A support surface for a patient support apparatus, comprising:
a core having an inflatable bladder assembly including
a first inflatable bladder including a first air impermeable flexible layer defining a first aperture,
a second inflatable bladder located adjacent to the first inflatable bladder and including a second air impermeable flexible layer different from the first layer, the second layer defining a second aperture axially aligned and overlapping with the first aperture,
a first patch connected to the first layer, the first patch extending across and covering the first aperture, and having an exterior face facing the second inflatable bladder, and
a second patch connected to the second layer, the second patch extending across and covering the second aperture, and having an exterior face facing the first inflatable bladder;
the exterior face of the first patch connected to the exterior face of the second patch at a patch connection thereby connecting the first inflatable bladder to the second inflatable bladder.

22. The support surface of claim 21, wherein the first patch is connected to the second patch by radiofrequency welding the exterior face of the first patch to the exterior face of the second patch.

23. The support surface of claim 22, wherein the first patch has an interior face incompatible for radiofrequency welding with an interior face of the second patch.

24. The support surface of claim 21, wherein:
the first patch is made of a first patch material;
the first layer is made of a first layer material; and
the first patch material and the first layer material are identical.

25. The support surface of claim 21, wherein:
the second patch is made of a second patch material;
the second layer is made of a second layer material; and
the second patch material and the second layer material are identical.

26. The support surface of claim 21, wherein the exterior face of the first patch is connected to an interior face of the first layer.

27. The support surface of claim 21, wherein the exterior face of the second patch is connected to an interior face of the second layer.

28. The support surface of claim 21, further comprising a cover including a top cover and a base cover, the top cover and the base cover being connected to enclose the core, the top cover defining a top surface of the support surface, and, when in use, the first inflatable bladder is located vertically between the top cover and the second inflatable bladder.

29. The support surface of claim 21, further comprising a casing enclosing the second inflatable bladder, the casing defining a casing aperture surrounding the first and second patches, the casing aperture being shaped and dimensioned to allow for the patch connection between the first and second inflatable bladders notwithstanding the presence of the casing.

30. The support surface of claim 21, further comprising a pneumatic control assembly fluidly connected to the second inflatable bladder, and at least one control box fluidly connected between the pneumatic control assembly and the first inflatable bladder, wherein:
the first inflatable bladder is part of a first pneumatic control zone controlled by the pneumatic control assembly and the at least one control box,
the second inflatable bladder is part of a second pneumatic control zone controlled by the pneumatic control assembly, and
the first and second pneumatic control zones are selectively inflated or deflated independently from one another by the pneumatic control assembly and the at least one control box.

31. The support surface of claim 30, wherein the first inflatable bladder is part of a percussion and vibration bladder system, and the second inflatable bladder is part of a comfort layer of the support surface.

32. The support surface of claim 31, wherein the pneumatic control assembly and the at least one control box are operable to vary over time a first pressure within the first inflatable bladder while maintaining a second pressure within the second inflatable bladder.

33. The support surface of claim 32, further comprising a support layer including an inflatable support bladder located below the comfort layer when the support surface is in use, the inflatable support bladder is fluidly connected to the pneumatic control assembly, and wherein the pneumatic control assembly is operable to maintain a third pressure within the inflatable support bladder while varying over time the first pressure within the first inflatable bladder.

34. The support surface of claim 21, wherein the patch connection is a first patch connection, the second layer further defines a third aperture, and the support surface further includes
a third inflatable bladder located adjacent to the second inflatable bladder and offset of the first inflatable bladder, the third inflatable bladder including a third air impermeable flexible layer different from the second layer, the third layer defining a fourth aperture axially aligned and overlapping with the third aperture,
a third patch connected to the second layer, the third patch extending across and covering the third aperture, and having an exterior face facing the third inflatable bladder, and
a fourth patch connected to the third layer, the fourth patch extending across and covering the fourth aperture, and having an exterior face facing the second inflatable bladder;
the exterior face of the third patch connected to the exterior face of the fourth patch at a second patch connection and thereby connecting the second inflatable bladder to the third inflatable bladder.

35. A method for forming an inflatable bladder assembly for an inflatable support surface for a patient support apparatus, comprising:
receiving a first air impermeable flexible blank defining a first aperture and a second air impermeable flexible blank defining a second aperture;
connecting a first patch to the first blank so as to extend across and cover the first aperture;
connecting a second patch to the second blank so as to extend across and cover the second aperture;
locating the first blank adjacent to the second blank to axially align and overlap the first patch with the second patch;
connecting an exterior face of the first patch to an exterior face of the second patch at a patch connection and thereby connecting the first blank to the second blank;
folding the first blank to have corresponding edges superposed and engaged to one another;
coupling the corresponding edges of the first blank in an airtight manner to form a first inflatable bladder;
folding the second blank to have corresponding edges superposed and engaged to one another; and
coupling the corresponding edges of the second blank in an airtight manner to form a second inflatable bladder.

36. The method of claim 35, wherein the connecting of the first patch includes connecting the exterior face of the first patch to an interior face of the first blank.

37. The method of claim 35, wherein the connecting of the second patch includes connecting the exterior face of the second patch to an interior face of the second blank.

38. An inflatable bladder assembly for a support surface for a patient support apparatus, comprising:
a first inflatable bladder including a first air impermeable flexible layer defining a first aperture,
a second inflatable bladder located adjacent to the first inflatable bladder and including a second air impermeable flexible layer different from the first layer, the second layer defining a second aperture axially aligned and overlapping with the first aperture,
a first patch connected to the first layer, the first patch extending across and covering the first aperture, and having an exterior face facing the second inflatable bladder, and
a second patch connected to the second layer, the second patch extending across and covering the second aperture, and having an exterior face facing the first inflatable bladder;
the exterior face of the first patch connected to the exterior face of the second patch at a patch connection and thereby connecting the first inflatable bladder to the second inflatable bladder.

39. The inflatable bladder assembly of claim 38, wherein the first patch is connected to the second patch by radiofrequency welding the exterior face of the first patch to the exterior face of the second patch.

40. The inflatable bladder assembly of claim 39, wherein the first patch has an interior face incompatible for radiofrequency welding with an interior face of the second patch.
